(19) United States
(12) Patent Application Publication
(10) Pub. No.: US 2006/0121411 A1
(43) Pub. Date: Jun. 8, 2006

(54) Cannula for a medical or dental medical handpiece used for spraying an abrasive flow medium

(75) Inventors: Hans-Dieter Wiek, Hochdorf (DE); Uwe Mohn, Schelklingen (DE); Bernd Gugel, Ulm (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Kaltenbach & Voigt GmbH & Co. KG, Biberach/Riss (DE)

(21) Appl. No.: 10/533,399

(22) PCT Filed: Oct. 20, 2003
(86) PCT No.: PCT/EP03/11600

§ 371 Date: Dec. 5, 2005

(30) Foreign Application Priority Data
Oct. 23, 2002 (WO) PCT/EP02/11866

(51) Int. Cl. A61C 3/02; A61C 17/02

(52) U.S. Cl. 433/88; 433/80

(57) ABSTRACT

The invention relates to a cannula for a medical or dental-medical handpiece for spraying a flow medium which contains abrasively effective particles, having a cannula shaft which is in substance straight, and a sideways directed outlet nozzle in the forward end region of the cannula shaft, wherein in the cannula shaft a first channel section of a delivery line extends axially forwardly, from which there extends a second channel section sideways to the outlet nozzle. In order to increase the working life, in the region of the apex of the angle included by the channel sections there is arranged an impact wall lying axially opposite to the first channel section and/or the channel sections are surrounded by a protective wall at least over a part of their length, wherein the impact wall and/or the protective wall are of a material that is more wear resistant or harder than the material of the cannula shaft.

The invention relates to a cannula for treatment of the human or animal body with an abrasive flow medium. Thereby, there is involved preferably a gaseous flow medium, in particular air or compressed air, with which abrasive particles, e.g. an abrasive powder, is mixed. The cannula consists of a cannula foot, a cannula shaft extending therefrom forwardly, and an outlet nozzle which is arranged in the forward end region of the cannula shaft and directed to the side. Through this, the treatment site arranged before the outlet nozzle is only slightly obscured by the cannula itself, and the person carry out the treatment has good access and a good view of the treatment site, even when this is located in a body cavity of the body, such as e.g. in the mouth of a patient.

The abrasive flow medium is sprayed-out of the outlet nozzle under pressure, and it can be used for the purpose of removing contamination of the surface, whereby the surface itself is treated gently. It is, however, also possible to abrasively work the surface itself, in order, e.g. to remove material from the surface itself. Thereby, the effectiveness of the flow medium is dependent upon the abrasiveness of the particles mixed therein.

To a cannula of the kind involved here, there belongs a handpiece or hand instrument from which the cannula stands out forwardly, and which forms a carrier for the cannula. In functional operation, the handpiece is manually grasped by the person carrying out the treatment and moved with the cannula to and at the treatment site. With most known handpieces of the kind concerned here, the abrasive particles are mixed into the air flow during the flow through the handpiece from a supply container arranged in the handpiece.

With a first kind of the cannula and the associated handpiece, the flow medium is of air or compressed air, to which there is mixed abrasive particles and water, which water is mixed with the mixture of air and particles in the region of the outlet nozzle, wherein the abrasive particles are of a material which upon wetting with water dissolves after a few seconds. Such a flow medium is suitable in particular for the cleaning of contamination from a surface. In dental-medical applications, contamination can be removed from the tooth surface, e.g. plague and surface stains, which may be caused e.g. through smoking. The abrasive particles may be e.g. of sodium bicarbonate NaHCO₃ (also called sodium hydrogen carbonate). A cannula with an associated hand instrument of the first kind is described e.g. in EP 0 834 291 B1.

In the case of a second kind of the cannula concerned and associated handpiece, particles are employed which are of greater abrasiveness and are of material which does not dissolve in water, e.g. aluminium oxide (Al₂O₃) or corundum grains. Such abrasive particles can form the flow medium only with air, i.e. without water, so that a water supply can be omitted.

A cannula both of the first and also of the second kind is subject, in its functional operation, to wear that is caused by the though-flowing abrasive particles. This wear takes place in particular in the region of the apex between the two delivery channel sections due to the change of direction of the flow medium which is caused.

The object of the present invention is, with a cannula of the kind concerned, to increase its working life. This object is achieved by means of the features of claim 1 or 30.

In the case of the configuration according to claim 1, the channels in accordance with the invention have, in the region of the apex, lying axially opposite the first delivery channel, an impact wall having an impact surface of a material which is more wear resistant than the material of the cannula shaft. This leads to an extension of the working life. Preferably, the material is, with regard to the abrasively effective particles, wear resistant such that no or only slight abrasion or wear takes place in functional operation. However, even when the material is only so wear resistant that the wear is reduced, the desired goal is attained of increasing the working life.

The advantages which can be attained by means of the invention apply with a corresponding configuration also when a protective wall surrounding the channel sections in the cannula is constituted corresponding to the invention. This configuration is suitable also in combination with an appropriate configuration of the impact wall, but also solely the constitution of the protective wall in accordance with the invention leads to the desired goal of increasing the working life, in particular when, for increasing the working life, a different solution is put to use in the region of the impact wall.

As material for the impact wall and/or protective wall alloy steel or hard metal is very well suited. It has however also been found that plastic is also suitable, in a surprising manner, for an impact wall and/or a protective wall, when its hardness and elasticity lay within indicated limits.

In the case of the configuration according to claim 30 there is arranged in the end region of the first channel section a channel widening. This channel widening forms a relaxation chamber in which, in operation of the cannula, the pressure and the flow velocity are reduced. Consequently, also the mass and abrasiveness of the abrasive particles is reduced, through which the wear at the end wall region laying opposite the first channel section is reduced. In order to attain the transition region between the channel widening and the second channel section a smooth and laminar flow, it is advantageous to provide in this transition region a convergent, in particular hollow cone shaped transition to the second channel section. Though this, not only is the flow improved, but also the abrasiveness of the particles in the second channel section is reduced and thus wear in the second channel section is reduced. In the case of cannula there is involved an object which in functional operation comes into contact with the human and/or animal body. Thereby it is to be taken into account that this contact in many instances takes place in an operation on the body, in which a particular sensitivity of the body is present. Thus, a cannula of the kind concerned is subject to particular requirements for its compatibility with the human or animal body. Further, particular requirements are placed on a cannula for its strength. The latter in particular from the point of view that a cannula should have a cross-section which is as small as possible and thus the loads to be expected should be taken up even in the case of a smaller or thinner structural form.

The invention thus further has the object, with a cannula of the kind indicated in the preamble of claim 2, to improve the compatibility with the body to be treated.

This object is achieved by means of the features of claim 2. Advantageous developments of the invention are indicated in the associated subclaims.

In the case of these configurations in accordance with the invention the cannula shaft is of a ceramic material. Through this the cannula is given not only an attractive and high-value exterior, but it is also of good compatibility with regard to the body, in particular with regard to different temperatures between the body and cannula. Since the cannula in accordance with the invention is a poor heat conductor, even in the case of relatively great temperature differences, no significant incompatibility arises.

Since the ceramic material can be worked by means of mold casting and pressing, this configuration makes possible also a simple and economical manufacture even when difficult conformations are involved. A further advantage of the configuration in accordance with the invention is to be seen in that in the case of the ceramic material there is involved a non-sensitive material that can be cleaned or disinfected or sterilized without problem, which in the case of a cannula for a medical or dental-medical handpiece is of significance. It is also advantageous to employ a hard ceramic material. Through this, the cannula is also more wear resistant.

The impact wall may be formed by means of an insert part, which preferably is emplaced and attached, e.g. screwed in, in a through-going receiving hole in the wall of the cannula. A favourable arrangement of the impact wall, with regard to the flow direction of the flow medium, is provided when this is arranged at right angles to the angle bisector of the angle included by the delivery channel sections, so that the angle included by the flow channel sections and the preferably plane impact wall is in each case the same, and the angle of incidence approximately corresponds to the angle of reflection.

It is then particularly advantageous to employ a flow medium that also includes water, when abrasive particles of a water insoluble material are used, because through the employment of the water the particles have less effect on the treatment space. For the delivery of the water there is needed, however, a second delivery line, which leads to a larger structural form of the cannula, which in particular should be avoided so that also small and difficult to access sites are accessible with the cannula as is e.g. the case in the mouth of a patient.

Thereby, naturally, a simple and economically producible construction should to be ensured.

The invention thus has further the object of so configuring a cannula of the kind indicated in the preamble of claim 16, that a simple and small structure is attained.

This object is achieved by means of the features of claim 16. Advantageous developments of the invention are indicated in the associated subclaims.

With the configuration according to claim 16, due to the coaxial arrangement of at least one section of the second delivery line, there can be attained not only a compact structure but also a simple structure, since due to the straight extension of the channel sleeve a simple pre-fabricated channel sleeve can be used and mounted by means of pushing in.

Since a cannula with the associated handpiece can be employed for different patients, hygiene has to be provided for and that contamination or pathogens cannot be transferred to the next patient. A particular region of danger is here, inter alia in particular the water delivery line, in which contaminants or pathogens can move particularly easily and thus be transferred rearwardly. This applies also for the abrasive particles in particular when they are of water insoluble material, but also when they are of water soluble material, because in the latter case the water is affected through the dissolving. Both the particles themselves and also the water after their dissolving, can contaminate and also affect the functioning of sensitive components in the rearwardly lying region of the cannula or also of a handpiece connected therewith, e.g. a releasable connection between the cannula and the handpiece or a releasable connection between the handpiece and an associated supply line.

The invention thus further has the object of improving the hygiene of a cannula of the kind concerned. Further, affecting of the water delivery line with contaminants and/or pathogens should be avoided or reduced.

This object is achieved by means of the features of claim 19.

With this configuration in accordance with the invention a return flow blocking valve is arranged in the water delivery line of the cannula. This is advantageous for several reasons. On the one hand such a blocking valve prevents the return transport of contaminants and/or pathogens, so that the hygiene is improved.

Further, by means of the blocking valve it is prevented that abrasive particles can reach into rearwardly lying regions of the cannula or also of the handpiece and cause functional disruptions. This applies in particular in the case of use of water insoluble particles, which could significantly damage the mechanics of the handpiece.

A cannula is a component which requires various production measures, both when only one delivery line extends through it and in particular when two delivery lines extends through it, e.g. working in of channels or mounting of line sleeves or nozzles or insert parts of wear resistant material. This is difficult on the one hand because of the elongate structural form and on the other hand because of the outlet nozzle to the side.

The invention thus further has the object of so configuring a cannula of the kind indicated in the preamble of claim 24 that it can be produced or also assembled more simply and with less outlay.

This object is achieved by means of the features of claim 24. Advantageous developments of the invention are indicated in the associated subclaims.

In the case of the cannula in accordance with the invention according to claim 24, the cannula shaft is of two longitudinal sections which are connected with one another by means of a connecting device in the form of a plug-in connection or screw connection. Through this it is possible to carry out the production or pre-fabrication or also installation measures on two cannula sections separated from one another. Thereby, the accessibility to the cannula sections is very much simplified in particular for internal production or installation measures, so that these measures can be carried out more simply, more quickly, and more economically.

Thereby, the longitudinal sections may be connected with one another by means of a plug-in connection or screw connection. In both cases there is arranged on the one longitudinal section a connection recess and on the other longitudinal section a connection pin, whereby the connection pin can be introduced and fixed in the connection recess, e.g. by pressing, gluing, soldering, welding or screwing in. It is advantageous to allow the outer surfaces of the longitudinal sections to so terminate with one another that they form no radial step and thus do not form an obstacle in the case of a sliding contact with the body to be treated.

The configuration in accordance with the invention is suitable in particular for a cannula in which two delivery lines extend, because in this case in particular the internal construction is complicated and is accessible from the outside only with difficulty or not at all.

A simple construction can be achieved when the second delivery line has a line section extending in the forward longitudinal section from the rear forwardly, e.g. axis parallel or obliquely, which extends towards the outlet nozzle. Upon arrangement of this line section in the side region of the cannula towards the outlet nozzle there is provided an advantageous construction, since the line section can extend directly towards the outlet nozzle and thus a simple construction is predetermined, which despite the radial offset makes possible a small construction. There contribute to this also further features of configuration of the cannula in accordance with the invention.

The invention relates also to a handpiece of the kind concerned having a supply container for the abrasive particles. In order to ensure a good functioning of the mixing of the particles with the air flow, a turbulence of the particles in the supply container due to the air flow is necessary, as is known, see EP 0 834 291 B1. Here, the supply container is subject to considerable wear, which significantly reduces its working life and the working life of the handpiece. This applies also for a channel or a channel sleeve which extends from the supply container forwardly.

The invention thus has the further object of extending the working life of a handpiece of the kind concerned. This object is achieved by means of the features of independent claim 24.

In the case of the configuration in accordance with the invention according to claim 24 at least the inner wall of the supply container and/or the channel sleeve is or are of a plastic material which is hard and or can be worn having a hardness (indentation hardness) of at least about 150 N/mm² in particular about 180 to 220 N/mm² in accordance with European standard EN ISO 2039-1. Through this it is attained in a surprising manner that the particles cannot exercise their abrasive effect on the wall surface, or exercise it only to a reduce extent. For the inner wall of the supply container and/or of the channel sleeve there is thus needed no hard metal, which is complex and expensive. Thus, this configuration in accordance with the invention also leads to a more simple and economical configuration, wherein plastic can be employed, which is economically suitable in particular as an injection molded part and for difficult conformations.

Further subclaims contain features which likewise lead to simple and economically producible manners of construction, ensure good functioning and make possible a simple and rapid installation or de-installation of releasable or also exchangeable components.

Below, advantageous configurations of the invention will be described in more detail with reference to preferred exemplary embodiments and the drawings. There is shown:

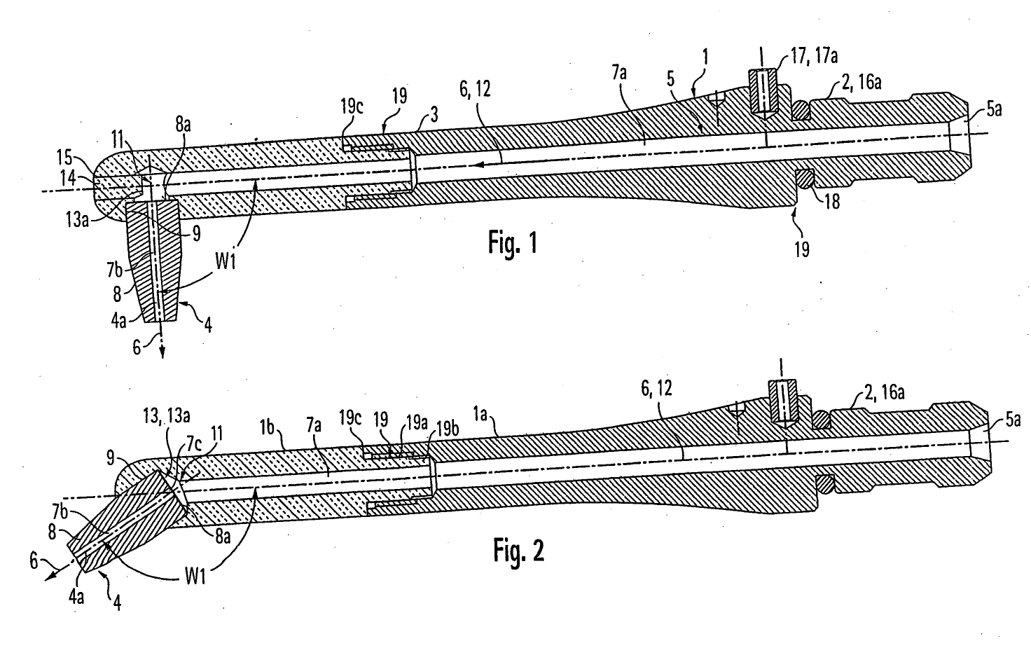

FIG. 1 a cannula in accordance with the invention, in axial section;

FIG. 2 the cannula according to FIG. 1 in modified configuration;

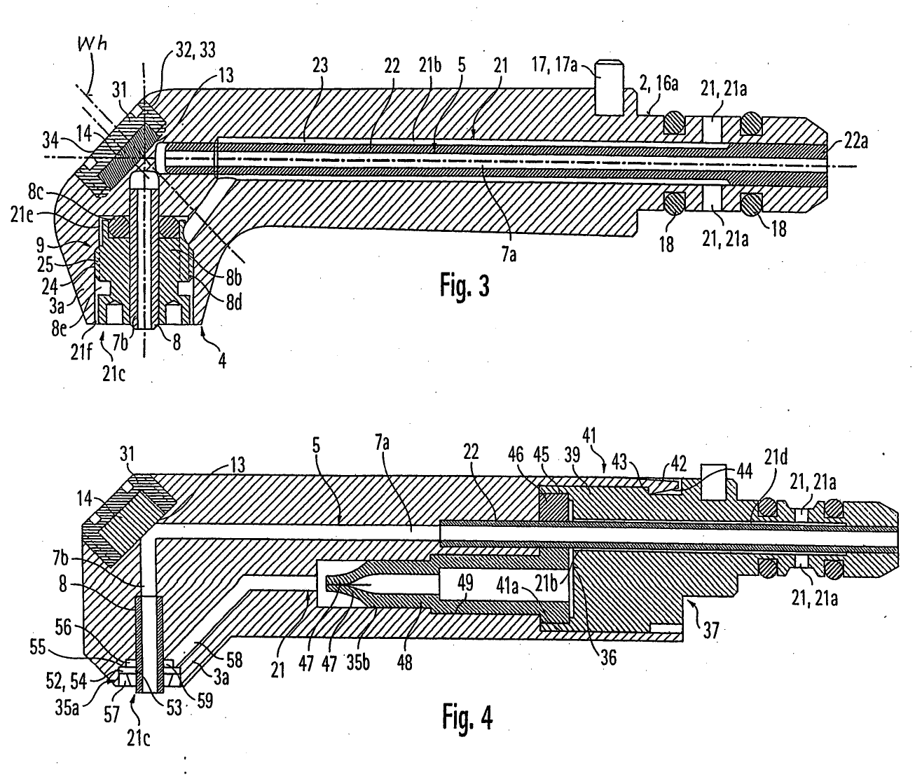

FIG. 3 a cannula in accordance with the invention in a further modified configuration, in longitudinal section;

FIG. 4 the cannula in modified configuration, in longitudinal section;

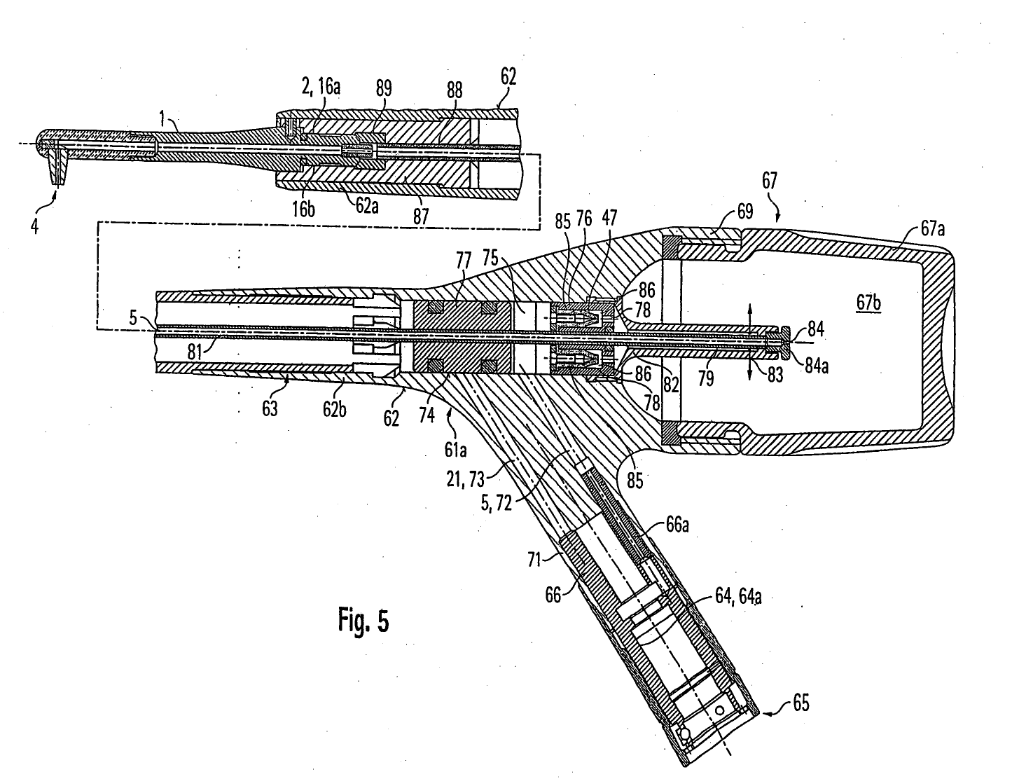

FIG. 5 a hand instrument with a cannula according to FIG. 1, in axial section;

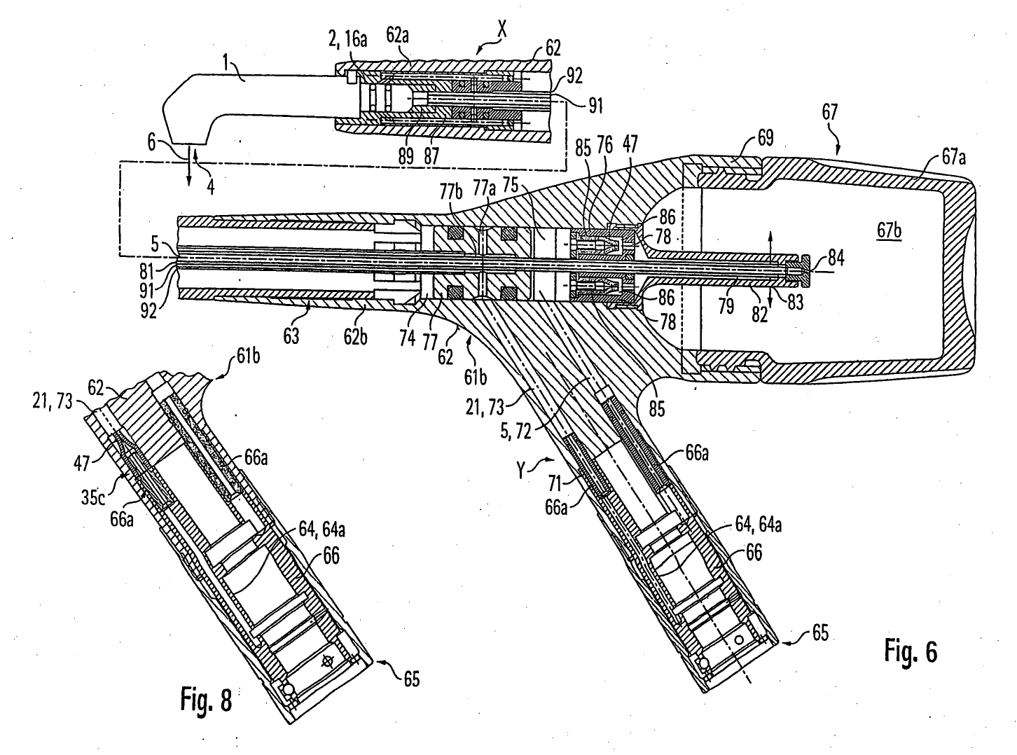

FIG. 6 a hand instrument for a cannula according to FIG. 3 or 4, in axial section;

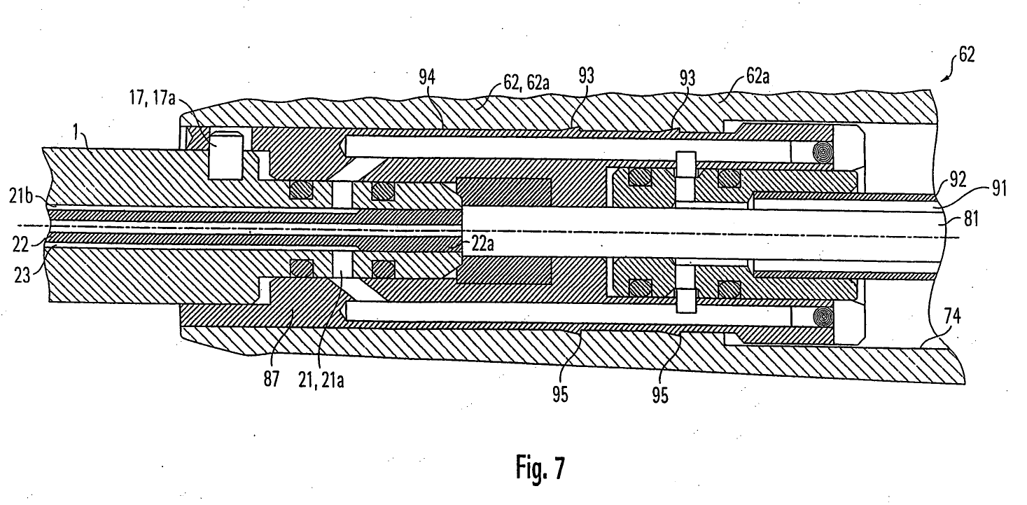

FIG. 7 the detail designated with the arrow X in FIG. 6, in a modified illustration to an enlarged scale;

FIG. 8 the detail designated by the arrow Y in FIG. 6, in a modified configuration;

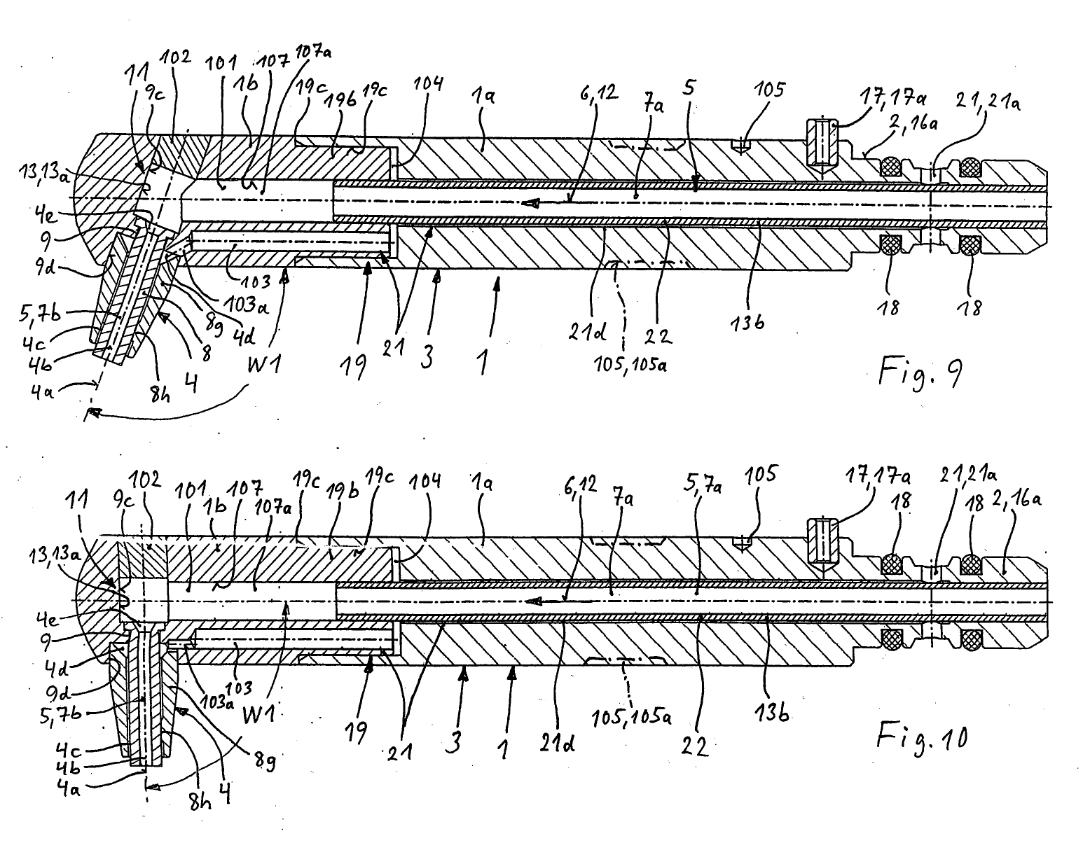

FIG. 9 the cannula in accordance with the invention in a further modified configuration, in axial section;

FIG. 10 a cannula in accordance with the invention in further modified configuration, in axial section.

The main parts of the cannula, designated in FIG. 1 in its entirety by 1, are a cannula foot 2, which is non-releasably or releasably connected with the forward end of a handpiece to be described below, a cannula shaft 3 extending from the cannula foot forwardly and substantially straight, an outlet nozzle 4, which is arranged in the forward end region of the cannula shaft 3 and directed to the side, and a delivery line 5 for a flow medium 6, wherein the delivery line 5 passes through the cannula foot 2 and the channel shaft 3, which are arranged coaxially with one another, with a first channel section 7a, from the forward end region of which a second channel section 7b extends to the outlet nozzle 4. The cannula sections 7a, 7b include a rearwardly open angle W1, which may be acute or approximately right angled, as shown in FIG. 1, or may be obtuse as FIG. 2 shows. The outlet nozzle 4 is located at the free end of a nozzle sleeve 8 which is fixedly emplaced in a receiving hole 9 in the cannula shaft 3 extending coaxially of the nozzle axis 4a, e.g. is glued or soldered or welded therein, wherein the receiving hole 9 may extend up to the first channel section 7a. In the exemplary embodiment, the nozzle sleeve 8 emplaced at its rearward face end flush with the inner wall of the first channel section 7a, so that its rearward end face 8a ends flush with the cylindrical curvature of the first channel section 7a. The cross-sectional size of the nozzle sleeve 8 is tapered towards its free end, in particular conically.

With the exemplary embodiment according to FIGS. 1 to 3, the flow medium is of an air flow (compressed air) in which particles of water insoluble material, e.g. corundum grains, or of water soluble material are mixed.

In the region of the apex 11 of the angle W1 there is arranged an impact wall 13 having an impact surface 13a, lying opposite the first channel section 7a in the flow direction, extending from the rear forwardly, in accordance with arrow 12, the material of which wall is more wear resistant than the material of the cannula shaft 3, which is preferably formed in one piece with the cannula foot 2. In the case of the exemplary embodiment of the impact wall 13 is formed by means of an insert part 14 which is fixedly emplaced in a receiving hole 15, preferably inserted from the outside and fixed, e.g. by means of a press fitting, gluing, welding or soldering. As FIG. 1 shows, the impact wall 13 may end flush with the forward wall section of the second channel section 7b or have a small forwardly directed spacing from this wall section. As material for the impact wall 13 or the insert part 14, hard metal or a wear resistant plastic is well suited.

A releasable connection for the cannula foot 2 is preferably formed by means of a plug fitting 16 having a plug-in pin 16a and a plug-in recess 16b receiving this pin with slight play for movement. The plug fitting 16 has associated therewith an arresting device 17 effective axially and in the circumferential direction. In the case of the exemplary embodiments, the plug fitting 16 and the arresting device 17 are in each case formed by means of a so-called bayonet fastening, whereby the plug-in pin 16a forms the cannula foot 2 and projects from the cannula shaft 3 rearwardly, and the plug-in recess 16b is arranged in the handpiece and opens forwardly. The arresting device 17 has a pin 17a radially upstanding from the cannula shaft 3 which is fixedly emplaced in an associated receiving hole 17b in the cannula shaft, and with which there is associated an angled recess at the forward end of the handpiece, into which the pin 17a can be introduced by insertion and turning, and is preferably latchable.

In functional operation of the cannula 1 or of the hand instrument having the cannula 1, the flow medium 6 containing the air and abrasive particles flows from the rear forwardly through the first channel section 7a, whereby it impacts on the impact wall 13 and is deflected into the second channel section 7b.

The cross-sectional size of the second channel section 7b is smaller than that of the first channel section 7a, whereby it may be dimensioned to be about half so big. The small inner cross-sectional size of the nozzle sleeve 8 leads to a concentrated jet of the flow medium 6. A first channel section 7a larger in cross-section increases the insensitivity with regard to a blockage caused by the abrasive particles.

The impact wall 13 or the insert part 14 and the nozzle sleeve 8 are preferably of hard metal, whereby the cannula shaft 3 may of corrosion resistant metal, e.g. of alloy steel. Due to the wear resistance of the impact wall 13 and of the nozzle sleeve 8, the cannula 1 is wear resistant. This means that wear in the region of the impact surface 13a and of the nozzle sleeve 8 may be present, but is so slight that it is negligibly small, as in the reminding region of the cannula shaft 3, the inner surface of which offers the particles little area to be attacked.

The plug fitting 16 may be sealed by means of a sealing ring 18 which in the exemplary embodiment is formed by means of an O-ring, which sits in a ring groove in the outer surface of the plug-in pin 16a or in the inner surface of the plug-in recess 16b.

The exemplary embodiment according to FIG. 2, in which the same or similar parts are provided with the same reference signs, differs from the above-described exemplary embodiment in two respects. On the one hand the outlet nozzle 4 is not directed sideways at right angles, but is directed obliquely forwardly, whereby the angle W1 included by the channel sections 7a, 7b is obtuse and may be e.g. about 100° to 160°, in particular about 110° or 150°.

On the other hand the impact wall 13 or the insert part 14 is formed by means of a section of the nozzle sleeve 8 extending before the first channel section 7a. This is attained in the case of the exemplary embodiment according to FIG. 2 in that the receiving hole 9 is extended into the region of the side of the first channel section 7a away from the outlet nozzle 4, preferably so far that the inlet opening 7c of the second channel section 7b is located in the region of the middle axis of the first channel section 7a. With this configuration, the flow medium 6 impacts against the rearward end of the nozzle sleeve 8. Since this also is of wear resistant material, in particular of hard metal, here also the cannula shaft 3 in the region of the apex 11 is protected from damaging wear.

It is advantageous to transversely divide the cannula 1 in the region between its cannula foot 2 and the apex 11 into a rearward and a forward cannula section 1a, 1b and to connected them by means of a connecting device 19. This connection may be releasable or non-releasable. This configuration has the advantage that different cannulas 1 can thereby be realized in that only the forward or rearward cannula section is formed differently, whereas the other cannula section in each case is formed to the same, and thus in each case a cannula section of the same construction can be put to use for different cannulas 1, as is the case with the exemplary embodiment according to FIG. 1 and 2, with which the forward cannula sections 1b are different and the lower cannula sections 1a are the same. Through this, the production is made substantially more simple, and also the production costs can be substantially reduced.

The connection device 19 can be formed by means of a plug connection having a plug-in pin and a plug-in recess receiving it, whereby the plug-in pin 19b may for example be non-releasably or releasably connected in the plug-in recess 19a, e.g. by insertion or pressing in or screwing. It is also possible to connect the forward and rearward cannula sections 1a, 1b by means of gluing, soldering or welding, whereby they may have the above described form of configuration for a different form of configuration.

In the case of the exemplary embodiment, the plug-in pin 19b extends from the rearward end of the forward cannula section 1b rearwardly, and it sits in the plug-in recess 19a which opens out at the forward end of the rearward cannula section 1a. The cannula sections 1a, 1b bear on one another at a preferably radial dividing joint 19c, which is formed by means of the ring end face surrounding the plug-in recess 19a and the step surface on the plug-in pin foot.

In the case of the exemplary embodiment according to FIG. 3, in which the same or similar parts are provided with the same reference signs, the cannula 1 has in the region of its cannula foot 2 a second delivery line 21 for the delivery of water, which extends forwardly from one or two inlet openings 21a in the middle region of the outer surface of the plug-in pin 16a initially radially inwardly and then parallel to the first axial channel section 7a, and then extends to the peripheral region of the outlet nozzle 4, in the region of which the second delivery line 21 exits as a slot-like ring opening 21c, e.g. out of a side annex 3a of the cannula shaft 3. Preferably the axial channel section 21b is formed as a ring channel surrounding the axial channel section 7a which in the case of the exemplary embodiment is formed between a channel sleeve 22 covering the axial channel section 7a and a ring hollow space surrounding this. In the case of the exemplary embodiment this ring hollow space is formed by means of a cylindrical cross-sectional tapering of the channel sleeve 22, whereby the channel sleeve 22 is fixedly emplaced with its rearward thickened end section 22a in a bore, here in a stepped bore 23 which in its forward end region is tapered at an axial spacing from the apex 11 to the cross-sectional dimension of the preferably hollow cylindrical channel sleeve 22, so that the channel sleeve 22 sits in its forward and in its rearward end region fixedly in the stepped hole 23 and therebetween is surrounded by the ring gap 21d.

In the case of the exemplary embodiment according to FIG. 3, the nozzle sleeve 8 does not stand out to the side from the cannula shaft 3, but is arranged in the annex 3a, which stands out to the side, in a sunken manner and surrounded by the ring nozzle 21c. The receiving hole 9 located in that annex 3a is a stepped bore having an inner thread 24 in its middle longitudinal region, whereby the outer longitudinal section 9a of the stepped bore is the same or somewhat greater than the outer diameter of the inner thread 24, and the longitudinal section 9b arranged inwardly of the inner thread 24 is dimensioned the same or smaller than the inner thread 24. The nozzle sleeve 8 has, in one piece or in two pieces, a thickened nozzle body 8b having a coaxial bore in which the nozzle sleeve 8 sits. The nozzle body 8b is formed stepped cylindrically with a middle external thread 25, screwed into the inner thread 24, a body section arranged inwardly of this and tapered, and an outer body section, which in each case have a ring spacing 21a, 21f to the receiving hole 9. The nozzle body 8b is with regard to the stepped bore 9 and the sleeve nozzle 8 sealed by means of a sealing ring 8c, which sits in a recess in the rearward end face of the nozzle body 8b. In the region of the outer thread 25b there extends an axis parallel channel 8d to an annular groove 8e in the nozzle body 8b, from which the ring spacing 21f extends axially. The sleeves 8, 22 form protective wall 13b which the abrasive particles pass gently along, in contrast to the impact surface 13a.

A further difference consists in that the impact surface 13a of the impact wall so extends approximately at right angles to the angle bisector Wh of the angle W1 that for particles impacting off the impact surface 13a for functional operation the angle of incidence is in substance the same as the angle of reflection.

A further difference may consist in that the insert part 14 is held on a releasable insert part carrier 31, which is releasably connected with the cannula 1, e.g. by means of a screw connection 32. The insert part carrier 31 may have an outer thread with which it is screwed into a threaded bore 33. In the case of the exemplary embodiment, the insert part carrier 31 and the insert part 14 have each the form of a disc, whereby the insert part carrier 31 ends approximately flush with its outer end surface with the peripheral surface of the cannula 1, e.g. as a plane end surface, which ends approximately flush with an incline 34. The insert part 14 may bear on the flat base of the bore 33 and sit in a recess in the carrier 31.

The exemplary embodiment of FIG. 4, in the case of which the same or similar parts are provided with the same reference signs, is likewise constituted to deliver a flow medium 6 of air, abrasive particles and water, and in comparison with the configuration according to FIG. 3 has several differences. A first difference consists in that in the second delivery line 21 there is arranged at least one valve 35, which blocks a return flow and thus forms a so-called non-return valve. Thereby, there may be provided two such return flow blocking valves 35a, 35b in the two delivery lines 21 in the region of the cannula 1, of which the first return flow blocking valve 35a is e.g. arranged in the region of the outlet nozzle 4 and a rearward return flow blocking valve 35a is arranged in the middle region of the cannula 1, in particular in a section 21g of the second delivery line 21 extending parallel to the first delivery line 5. The transverse connection to the parallel section 21g of the second delivery line 21 is formed by means of a transverse channel 36 arranged upstream of a return flow blocking valve or of the rearward return flow blocking valve 35a. In the rearward end region and (in the region of the first channel section 7a) the exemplary embodiment according to FIG. 4 corresponds in principle with the channel sleeve 22 substantially to the exemplary embodiment according to FIG. 3, but the channel sleeve 22 may be shorter and end upstream of the transverse channel 36.

The parallel delivery line section 21g is preferably accessible from the rear, so that the associated return flow blocking valve 35a can be introduced or is exchangeable from the rear. For this purpose the parallel section 21 of the second delivery line 21 may be accessible from the rear and closable by means of a closure part. In the case of the exemplary embodiment, the closure part designated by 37 is releasably connected from the rear with the cannula 1. Preferably there is provided a quick-fastening connection device 41, e.g. a latching device or a bayonet connection. The closure part 37 may be plug-in pin 39 which can be inserted from the rear into a rearwardly open plug-in recess 41a in the cannula 1 and is securable, e.g. by means of a turning movement in the case of a bayonet connection or by latching in each case at the end of the insertion movement. A latching device can e.g. be formed by means of one or more latching noses 42 distributed around the circumference, which are arranged on the circumferential wall of the plug-in recess 41a so that they can radially spring outwardly and in each case engage behind a latching edge 43 of the plug-in pin 39, e.g. a rearwardly tapered step surface on the plug-in pin 39. The at least one latch nose 42 may have an oblique or rounded introduction surface 44, which upon insertion of the plug-in pin 39 into its plug fitting self-actingly brings about a springing out of the latch nose 42, whereby the latter self-actingly latches in at the end of the insertion movement.

In the case of the exemplary embodiment, the closure part 37 is a carrier of the cannula foot 2, whereby the arresting device 17, e.g. with the pin 17a, may be arranged on the component 40 formed in common by the closure part 37 and cannula foot 2.

In the case of the exemplary embodiment, the closure part 37 has at its forward end a recess 45 in which the rearward end of the return flow blocking valve 35a sits, preferably with a flange 46, which extends eccentrically up into the region of the first delivery line 5 and has a through-hole for the channel sleeve 22, which preferably forwardly projects beyond the flange 46. The transverse channel 46 may be formed by means of a depression of the base of the recess 45.

In the case of this exemplary embodiment, the ring gap 21d surrounding the channel sleeve 22 is thus arranged in the component 40.

The blocking valve 35a is preferably a lip valve having at least one or two forwardly extending lips 47, which are substantially closed in the relaxed condition, which may extend from a sleeve-like base body 48 which if appropriate may have a forwardly tapered step and is inserted from the rear with slight play for movement in a bore 49 widening the cross-section of the second delivery line 21, whereby the bore 49 extends up to in front of the lips 47.

The other blocking valve 35b, preferably arranged in the region of the outlet nozzle 4, is in particular a membrane valve having a membrane 52 which can be moved into its open disposition, against its own elasticity, by means of the flow of water and in the absence of the flow self-actingly springs back into its closed disposition due to its self elasticity.

In the case of the exemplary embodiment, the membrane 52 is a ring disk of elastically bendable material, e.g. rubber or plastic, which sits with its inner edge on the nozzle sleeve 8, preferably formed as a thin tube, and is fixed at its outer edge, e.g. between the base or a shoulder surface 55 of a hole 56 surrounding the nozzle sleeve 8, in which hole there is fixedly placed, e.g. screwed in, a clamping ring 57 clamping the outer edge 54 against the shoulder surface 55. The second delivery line 21 for water opens, e.g. by means of a channel section 58 extending forwardly divergently or obliquely, downstream of the membrane 52, e.g. in a base region 59 of the hole 56, formed by means of the shoulder surface 55 in the form of a step surface, which base region surrounds the nozzle sleeve 8 in a ring shape.

When the water flows through the blocking valves 35a, 35b, both valves are self-actingly opened by means of the flow pressure, whereby the case of the blocking valve 35a the lips 47 are spread apart and in the case of the. blocking valve 35b the inner edge 53 of the membrane 52 is elastically bent outwardly in the direction of flow, and thereby lifts up from the outer surface of the nozzle sleeve 8 and thereby makes free a ring gap through which the water flows out forwardly and can form a sleeve of water directed to the treatment site. In particular the blocking valve 35b with a membrane 52 leads, due to the axial return movement, to a return suction effect at the ring nozzle 21c, through which drop formation is avoided. As already in the case of exemplary embodiments according to FIGS. 1 and 2, also in the case of the exemplary embodiments according to FIGS. 3 and 4, in each case the carrying base body of the cannula 1 may be of corrosion resistant material, e.g. alloy steel.

In the case of all above described exemplary embodiments it is, however, also advantageous for several reasons to form at least the carrying body of the forward section 1b of the cannula 1 or the carrying body of the cannula 1 as a whole, of ceramic. This material is thermally insulating and thus particularly well suited, in the case of contact with the human body, to avoid contacts between the body to be treated and the cannula 1 which are perceptible as unpleasant as a result of temperature difference. Since ceramic can be cast and/or pressed in a mold, through this a simple and economically production is possible as a cast or pressed part.

In particular when the cannula 1 is to serve for the delivery of water insoluble particles, it is advantageous to line the ceramic body of the cannula 1 in the region of the first and second channel sections 7a, 7b with protective walls 13b, in particular with sleeves 22, 8 as is illustrated by way of example in FIG. 3, whereby the abrasive particles flow through the sleeves 22, 8 and are deflected at the impact wall 13. The channel sleeve 22, the impact wall 13 and the nozzle sleeve 8 may be of sufficiently wear resistant material, e.g. hard metal. The insert part carrier 31 and the nozzle body 8d may be of corrosion resistant steel.

For screwing in and out of the insert part carrier 31 and of the nozzle body 8b these have an externally accessible rotational engagement element.

In FIG. 5 there is illustrated by way of example a handpiece 61a which can be equipped with a cannula 1 in accordance with FIGS. 1 and 2 and which can serve for the delivery of a flow medium 6 with particles soluble in water. Such a handpiece 61a is largely described in EP 0 834 291 B1. Reference is made to this publication to the full extent, so that it is part of this description and the following description can consequently be reduced. The main parts of the handpiece 1 are a rod-shaped handpiece body 62, which at its forward end has a connection element matching the cannula 1, here a plug-in recess 16b matching the plug fitting 16. The handpiece body 62 is of a forward grip part 62a and a rearward shaft 62b which are mounted on one another freely rotatably about their middle axis by means of a rotary bearing 63. The rearward shaft 62b has a coupling element 64 of a plug-in/turn coupling 65, by means of which the handpiece 62 can be releasably connected in a handling friendly manner and quickly with a non-illustrated flexible supply line, through which the first delivery line 5 for air and the second delivery line 21 for water extend, and in which the component of the shaft 62b carrying the coupling element 64 continues and preferably extends through the insert part 66, which has a manufacturer-specific coupling element 64 and is exchangeable, so that the handpiece 1 can be adapted to manufacturer-specific connection configurations. In the case of the exemplary embodiment according to FIG. 5, the delivery line 21 for water can be omitted. It is, however, present for reasons of having like constituted shaft parts 62b.

There is also arranged on the shaft 62b a supply container 67f or abrasive particles which can be selectively opened and closed, e.g. in the form of a supply stopper 67a which can be screwed on and screwed off with a thread, in particular outer thread 68, arranged at its free edge, with which it can screwed into an inner thread of a thread support 69 in a sealed manner, which thread support is preferably arranged, in particular coaxially, rearwardly on the shaft 62b. In the case of the exemplary embodiment the shaft 62b has a lateral coupling annex 72 in the free end region of which the coupling element 64 is formed, here in the shape of the cylindrical or stepped cylindrical plug-in recess 64a.

From the coupling element 64 the delivery lines 5, 21 run as channels 72, 73 to an axial through-channel 74 for receiving the components directing the flow medium 6, whereby the through-channel 74 is accessible from the supply space 67b of the supply container 67 arranged behind it and is accessible forwardly to the connection with the cannula 1.

A delivery line section extending axis parallel in the insert part 66 and opening out of the insert part 66 at the forward end is connected in a sealed manner with the handpiece body 62 by means of a sleeve 66a, whereby the sleeve 66a is inserted as a plug-in part in the insert part 66 and in the handpiece body 62.

The channel 72 for air opens in a free space 75 in the through-channel 74 between a rearward and a forward insert part 76, 77. From free space 75 the delivery line 5 extends in the form of one or more off-centre through channels 78 in the insert part 76 and then further through a ring channel 79 between a coaxial channel sleeve 81 and an outer sleeve 82 in the middle region of the supply space 67b, in which the ring channel 79 opens with one or more outlet openings 83 preferably in the middle region. At the rearward end of the channel sleeve 81 there is provided an inlet opening 84 preferably in a screw nozzle 84a, through which in functional operation the air-particle mixture flows forwardly coaxially through the channel sleeve 81 and through the handpiece body 62. In the through-channel or channels 78 there is or are arranged in each case a return flow blocking valve 85, which prevents a return flow in particular of abrasive particles. Through this contamination and disruptions are avoided which the particles could cause upstream of the supply space 67b, in particular in the region of the coupling element 64. Preferably there is emplaced and fixed in the through-channel 78 at least one lip valve having one or two lips 47, so that the at least one sealing lip 47 can move in a free space 86 which is formed by means of a stepped bore, in which the sleeve body of the blocking valve 85 sits. The lips 47 are rearwardly directed and open in the case of a flow into the supply space 67b and close self-actingly in the case of a return flow. With this configuration, the insert part 76 is accessible from the supply space 67b and thus mountable and de-mountable, e.g. in order to carry out cleaning measures or to exchange the blocking valve or valves 85. In the case of the exemplary embodiment this can be effected after a release of the outer sleeve 82, which likewise can be emplaced and removed from the supply space 67b or from the rear, and which may serve for fixing of the insert part 76, e.g. by means of radial clamping effect, or as a screw part.

The channel sleeve 81 extends freely passing through the rotary bearing 63 up into an insert part 87 sitting in the forward end region of the handpiece body 62 in which insert part it is rotatably mounted in a bearing bore 88 and reaches into the region of a ring seal 89 which sits in the base of the plug-in recess 16b and seals off the cannula foot 2, here the plug-in pin 16a, by means of axial pressure. The insert part 87 is formed with a rearward step, stepped cylindrically and inserted from the rear through the through-channel 74 in the handpiece body 62 or in the grip part 62a.

The delivery channel 73 is blocked by means of the other insert part 77 because in the case of this exemplary embodiment of the handpiece 61a it not necessary.

The exemplary embodiment according to FIG. 6 differs from that according to FIG. 5 in that the water delivery line 21 extends through the insert part 66 and the through-channel 74 to the connection element for the cannula 1 and is there connected sealed with the coaxial inlet opening 5a. For this purpose there may be provided an outer channel sleeve 92 surrounding the channel sleeve 81 with a ring gap 91, the rearward end of which outer channel sleeve sits in the insert part 77, whereby the delivery line 21 extends in the insert part 77 through radial and axial channels 77a, 77b to the ring gap 91 of the channel outer sleeve 92. In the forward end region of the handpiece body the ring gap 92 is carried further forward by means of radial and axial channels 87a, 87b in the insert part 87, where the thus formed delivery line 21 stands in connection with the inlet opening or openings 21a in the cannula foot 2. Air and water can be delivered at the same time to the cannula 1. Also for connection of the insert part 66 with the handpiece body 62 there serves a sleeve 66a which sits in an axis-parallel delivery line section in the insert part 66 and engages and is sealed in the channel 73.

In particular when no return flow heat valve 35a, 35d is located in a cannula 1 for a handpiece 61b, or in addition thereto, a return flow blocking valve 35c may be arranged in the delivery line for water in the region of the handpiece 61b, which in the case of the exemplary embodiment according to FIG. 8 is arranged downstream of the insert part 66 in the handpiece body 62, preferably directly behind the insert part 66, so that the blocking valve 35c is, after a removal of the insert part 66 from the coupling connection support present, accessible. Also the blocking valve 35c opens with a forwardly directed flow and blocks with a rearwardly directed return flow, in each case self-actingly. This blocking valve 35c may be a lip valve with one or two lips 47 effective against one another and forwardly directed. Also the remaining structure of the blocking valve 95c may correspond in substance with the configuration of the blocking valve 35b. The sleeve-like body of the blocking valve 35b preferably sits both in a forwardly opening delivery line section of the insert part 66 and also in a channel 73 adjoining thereto which if appropriate may be widened. Through this, the blocking valve 35c may replace the associated through-flow sleeve 66a according to FIG. 6.

FIG. 7 shows an illustration to an enlarged scale of the handpiece 61b according to FIG. 6 in the region of a modified insert part 87 which sits in the through-channel 74 and is preferably insertable from the rear. For axial fixing against an axial displacement, the insert part 87 may be fixed in the handpiece body 62 or in the grip part 62a by means of a press fitting. Since the insert part 87 upon emplacement of the cannula 1, is particularly rearwardly subject to load, a rearwardly blocked latching for the insert part 87 is particularly advantageous. In the case of the exemplary embodiment there are provided one or more sawtooth-shaped recesses, arranged axially behind one another, or ring grooves 93 in the inner wall 94 of the through-channel 74. In these recesses or ring grooves 93, wall parts or corresponding radial projections 95 of the insert part 87 can latch in. In particular when the insert part 87 is of slightly elastically compressible material, e.g. plastic. The sawtooth shape of the ring grooves is rearwardly directed. Thus, the insert part 87 with the slightly inclined flanks of the projections 95 can be readily inserted, whereby the teeth of the projections latch into the ring grooves. With this configuration both the cannula connection and also the connection of the sleeve 81 or sleeves 81, 92 is formed at a single component, namely the insert component 87. In functional operation of the handpieces 61a, 61b in particular of the handpiece 61b that is operated with water insoluble particles, the particles in the supply container 67 are swirled by the airflow to attain a good and uniform mixing with the airflow and they then flow through the sleeves 82, 22 or small tubes to the impact wall 13, at which they are deflected and from which they flow through the nozzle sleeve 8. Upon the movement of the particles the inner surfaces of the above-mentioned parts are subject to wear. In order to ensure a relatively long working life it is advantageous to produce these parts of a wear resistant material, e.g. of hard metal or of a wear resistant plastic or to coat them internally with a hard metal or the like or a wear resistant plastic. Insofar as the supply container 67 is concerned, these measures apply for the supply container 67 overall or only for the pot-shaped container part 67a.

It has been determined in trials that plastics with a degree of hardness between about 70 to 100 Shore or a degree of hardness between at least about 150 N/mm² in particular about 180 to 220 N/mm² in accordance with European standard EN ISO 2039-1, are well suited whilst ensuring a relatively long working life. It is further advantageous if the modulus of elasticity of the plastic concerned in tensile testing (Gpa) is 3.2 to 4.5, in particular about 3.8. It has further been determined that the plastics polyetheretherketone (PEEK) or polyurethane (PUR) are well suited for the above-described wear resistant structure or coating. It has further been determined that PEEK plastic, in particular having a degree of hardness of at least about 150 N/mm², in particular about 180 to 220 N/mm² in accordance with European standard EN ISO 2039-1, is particularly well suited for the wear resistance formation or coating of the supply container 67 and/or at least one of the sleeves 81, 22, 8. This can be explained in that the PEEK plastic has a greater hardness.

It has further also been determined that a PUR plastic is particularly well suited for an impact wall 113 or a corresponding insert part 14. This can be explained in that PUR plastic has a greater elasticity, which works favourably with regard to the impact effect, in the sense of an improvement (wear resistance).

For the present purposes, polyetheretherketone (PEEK) and polyurethane (PUR) molding resins are very well suited, in particular elastomer molding resins for hot molding in accordance with the “Vulkollan” principle, which are three component systems. They consist of long chained adipine ester dioles, which before the casting must be completely degassed and dewatered by heating under vacuum in the casting vessel, the very reactive NDI (MP 120° C., see table 4.65, 3, page 470), which when provided in excess forms long chained but not stable intermediate products, and finally a lastly added small component of a simple glycol or a similar chain lengthening and—through reaction 4 or 5, table 4.66, page 472—cross-linking material. The cross-linking begins directly upon casting, the products are however after de-molding, subsequently heated at 80 to 140° C. for complete curing. This type of tough rubber elastic elastomer with a large usable temperature range (table 4.68) is extremely wear resistant and resistant to lubricants, many solvents and weathering. Cellular elastomers of this type with densities from 0.25 to 0.65 g/cm³ are produced with the addition of measured amounts of water. Due to their cellular structure they are compressible without side deformation and exhibit a very favourable damping and impact return behaviour.

Beyond these types, there are also two component thermal casting resins with stable polyether MDI prepolymers. In comparison to the above-mentioned systems these are simpler to process, mechanically not quite so good, but more hydrolysis resistant.

The plastic for the supply container or the container part 67a is preferably non-transparent, e.g. penetration dyed, in particular penetration dyed black. Through this, evidence of wear on the inside is not visible.

The above-described plastics thus are suitable because of their wear resistance also as impact wall 13 and protective wall 13b for the delivery line 5. Thus, these plastics can also be used as material for the nozzle 4a and/or the sleeve channel 81 and/or the sleeve channel 22 and/or the sleeve channel 8 and/or the impact wall 13, whereby a long working life is ensured.

The exemplary embodiments according to FIG. 9 and 10, in which the same and similar parts are provided with the same reference signs, include combination features of the above-described exemplary embodiments, whereby they have in particular a combination of the exemplary embodiments according to FIG. 1 and 2 with an additional delivery line 21 for a liquid, in particular water. The rearward section of the cannula 1 may in substance correspond to the exemplary embodiment according to FIG. 1 in which the two delivery lines 21 extend in the region of the plug-in pin 16a radially inwardly and then forwardly as axial channel section 21d in the form of a ring channel. Thereby, the axial channel section 21d extends up to the dividing joint between the rearward and forward cannula section 1a, 1b. The channel sleeve 22 projects beyond the dividing joint and extends into the forward cannula section 1b, where it sits in a fitting manner in a channel section 101 of the forward cannula section 1b and is sealed therein, e.g. by means of the fitting present or in that it is glued into the channel section 101. Thereby, the channel sleeve 22, with the exception of its rearward end region, may be tapered as is shown in FIG. 3 or the channel sleeve 22 may be formed as a hollow cylindrical sleeve, whereby the axial channel section 21b may be formed by means of a channel extension extending from the plug-in pin 16a to the plug-in recess 19a, as shown in FIGS. 8 and 9.

As already in the case of the exemplary embodiments according to FIGS. 3 and 4, the exemplary embodiments according to FIGS. 8 and 9 also have a common outlet nozzle 4 for the first and the second delivery line 5, 21, whereby a central outlet channel 4b is provided for the air delivered through the first delivery line 5 and transporting abrasive particles, and a ring channel 4c surrounding the central outlet channel 4b at a ring spacing is provided for the liquid, in particular water.

The central outlet channel 4b is located in the hollow cylindrical nozzle sleeve 8 which preferably has at its inward end a flange 8f in which it sits in the receiving hole 9, if appropriate widened in a step form in adaptation to the flange 8f, and is fixed therein, e.g. by means of press seating or by gluing. In particular when the nozzle sleeve 8 has a flange 8f, the receiving hole 9 is formed as a through-hole with a hole section 9c extended towards the side away from the outlet nozzle 4, which on the other side of the channel section 101 is closed by means of a stopper 102 emplaced in a fixed and sealed manner, the outer end face of which ends flush with the preferably cylindrical outer surface of the cannula 1.

The ring channel 4c is formed by a second outer nozzle sleeve 8g surrounding the inner first nozzle sleeve 8 at a ring spacing, which second outer nozzle sleeve is fixably emplaced and sealed in a hole widening 9d. The inner nozzle sleeve 8 may slightly project beyond the outer nozzle sleeve 8g.

The second delivery line 21 extends to the rearward end of the ring channel 4c or the outer nozzle sleeve 8g, whereby it is radially connected with the ring channel 4c. Preferably there is provided in the region of the flow deflection between the end section of the delivery line 21 extending in substance parallel to the longitudinal axis of the cannula 1 and the ring channel 4c a connecting channel section 4d which extends obliquely or in a conical form, which in the case of the exemplary embodiment is formed by means of a cone-like introduction surface of the rearward or inner end of the outer nozzle sleeve 8g. Through this oblique or convergent form of the connection section 4d there can be obtained a disruption-free and smoothed flow. There extends to the connection channel section 4d an oblique and/or approximately axis parallel delivery channel section 103, which extends from the rearward side of the plug-in pin 19b and which can be worked into the forward cannula section 1b, e.g. by boring from the rear or from the fore, before this is connected with the rearward cannula section la or with the nozzle sleeves 8, 8g. There may adjoin the axis-parallel delivery section line 103 an oblique (FIG. 9) or outwardly offset and/or tapered line section 103a which opens into the connection section 4d.

For connection of the ring-shaped axial channel section 21b with the eccentric delivery line section 103 there is provided a connection channel 104 extending in substance radially which is preferably formed by means of a ring free space between the base of the plug-in recess 19a and the plug-in pin 19b.

For stabilizing the inner nozzle sleeve 8 there can be provided a support cam 8h, standing up from the outer surface of the inner nozzle sleeve or preferably from the inner surface of the outer nozzle sleeve 8g, which passes through the ring channel 4c. There may be arranged a plurality of support cams 8h, e.g. two or three distributed on the circumference. The support cam or cams 8h have preferably an axial spacing from the edge of the outer nozzle sleeve 8g.

In order to facilitate the mounting or de-mounting with or from the handpiece, it is advantageous to form on the cannula 1 a rotary engagement element 105 for a rotary tool so that it can be more easily connected with or separated from the handpiece. In the case of the exemplary embodiment the rotary engagement element 105 is provided by means of a so-called wrench span having two flattenings or secantial span surfaces 105a, which are preferably arranged in the rearward foot region of the cannula and extend preferably parallel to the longitudinal middle plane containing the outlet nozzle. The rotary engagement element 105 may also be formed by means of a radially blind hole 105b.

The exemplary embodiments according to FIGS. 9 and 10 differ from one another in that with the exemplary embodiment according to FIG. 10 the outlet nozzle 4 or the channels 4b, 4c extend approximately at right angles W1 to the cannula axis, while in the case of the exemplary embodiment according to FIG. 9 they include with the cannula axis an obtuse angle W1 which is e.g. 90° to 120°, preferably about 110°.

In particular in the case of an outlet nozzle 4 standing out at right angles, but also in the case of such having an outlet nozzle 4 standing out with an obtuse angel W1, it is advantageous to form in the end region of the axial channel section 101 a channel widening 107 which in the case of the exemplary embodiment may be formed through the absence of the channel sleeve 22 in the forward end region of the channel section 101. Through this there is formed an enlarged relaxation chamber, which serves for the pressure reduction of the pressure and of the flow velocity. The relaxation chamber 107a thus contributes to the reduction of the abrasive effectiveness of the particles through which the wear at the end wall lying opposite to the channel section 101 is reduced. When in functional operation of the cannula 1 the abrasive particles at the end of the channel section 101 work out a cavity by means of removal of material. This is of no significance, because abrasive particles remain in the so formed pool and deflect following particles with the same hardness so that the removal of material at the wall region lying opposite to the axial delivery line section 1a comes to a standstill. Due to the channel restriction between the relaxation chamber 107a and the central outlet channel 4b there arises in the latter again an increase of the flow velocity which with regard to a desired material removal performance on the object to be subject to the spraying, in particular at the tooth, is desired.

Here, the for example conical-shaped convergent outlet channel 4a, due to a chamfer 4e to the rear, brings about that the abrasive particles are directed through the outlet channel 4a in a laminar flow.

The cross-sectional form of the cannula 1, preferably extending straight, is in particular round, preferably cylindrical.

In the case of all exemplary embodiments it is advantageous for reduction of the wear and for extension of the working life to produce the parts which form guide or contact walls for the particle flow of ceramic, plastic, stainless steel or hard metal, or to line them with one of these materials. Here, there may be involved the following parts, namely the supply container 67, the supply stopper 67a, the channel sleeve 81, the sleeve 22, the body of the cannula 1, the forward cannula section or both cannula sections 1a, 1b and/or the nozzle sleeve 8 or 8g. Ceramic is suitable for the reasons already given also for the outer parts of the cannula 1, which could come into physical contact with the body to be treated, e.g. the cannula body or the nozzle sleeve 8g.

As ceramic material there are suited technical ceramics, e.g. boron carbide, zirconium oxide, silicon carbide or aluminium oxide. Stainless steel is such an alloyed steel the alloy components of which are greater then 5% and which beyond this is rust and acid resistant. As hard metal there is preferably suited sintered hard metal. With regard to the plastic, attention is directed to the above-described wear resistant plastics, which are very well suited for the mentioned parts.

1. Cannula (1) for a medical or dental-medical handpiece (61a) for spraying a flow medium (6) which contains abrasively effective particles, having
a cannula shaft (3) which is in substance straight
a sideways directed outlet nozzle (4) in the forward end region of the cannula shaft,
wherein in the cannula shaft (3) a first channel section (7a) of a delivery line (5) extends axially forwardly, from which there extends a second channel section (7b) sideways to the outlet nozzle (4)
wherein in the region of the apex (11) of the angle (W1) included by the channel sections (7a, 7b) there is arranged an impact wall (13) lying axially opposite to the first channel section (7a).
and/or the channel sections (7a, 7b) are surrounded by a protective wall (13a) at least over a part of their length,
and wherein the impact wall (13) and/or the protective wall (13a) are of a material that is more wear resistant or harder than the material of the cannula shaft (3).

2. Cannula (1) for a medical or dental-medical handpiece (61a) for spraying a flow medium (6) which contains abrasively effective particles, having
a cannula shaft (3) which is in substance straight
a sideways directed outlet nozzle (4) in the forward end region of the cannula shaft,
wherein in the cannula shaft (3) a first channel section (7a) of a delivery line (5) extends axially forwardly, from which there extends a second channel section (7b) sideways to the outlet nozzle (4), characterized in that,
that the cannula shaft (3) is of a ceramic material.

3. Cannula according to claim 2,
characterized in that,
in the region of the apex (11) of the angle (W1) included by the channel sections (7a, 7b) there is arranged an impact wall (13) lying axially opposite to the first channel section (7a).
and/or the channel sections (7a, 7b) are surrounded by a protective wall (13a) at least over a part of their length,
and wherein the impact wall (13) and/or the protective wall (13a) are of a material that is harder or more wear resistant than the material of the cannula shaft (3).

4. Cannula according to any preceding claim,
characterized in that,
the material of the impact wall (13) and/or of the protective wall (13a) is harder or more wear resistant that the material of the cannula shaft (3), and is preferably of hard metal.

5. Cannula according to any preceding claim,
characterized in that,
the impact wall (13) and/or the protective wall (13a) is of a plastic of a hardness of about 70 to 100 Shore or at least about 150 N/mm², in particular about 180 to 220 N/mm², in accordance with the European standard EN ISO 2039-1.

6. Cannula according to claim 5,
characterized in that,
the plastic is of polyurethane (PUR) or
polyetheretherketone (PEEK).

7. Cannula according to any preceding claim,
characterized in that,
the protective wall (13a) is in each case formed by means of a sleeve (8, 22).

8. Cannula according to claim 7,
characterized in that,
the nozzle sleeve (8) of the second channel section (7b) stands out to the side from the cannula shaft (3).

9. Cannula according to any preceding claim,
characterized in that,
the impact wall (13) is formed by means of an insert part (14) which sits releasably or non-releasably in a receiving hole (9) in the cannula shaft (3).

10. Cannula according to any preceding claim,
characterized in that,
the outlet nozzle (4) includes with the cannula shaft (3) an angle (W1) which is acute or is about 90° or is obtuse.

11. Cannula according to any of preceding claims 6 to 8,
characterized in that,
the sleeve (8) sits in a receiving hole (9) in the cannula shaft (3) at least with its rearward end region.

12. Cannula according to claim 11,
characterized in that,
the insert part (14) is arranged at the rearward end of the sleeve (8) on its forwardly directed side.

13. Cannula according to claim 11 or 12,
characterized in that,
with an arrangement of the outlet nozzle (4) at an obtuse angle (W1) the receiving hole (9) extends at least to the side of the first channel section (7a) away from the outlet nozzle (4) and the sleeve (8) likewise extends to the side of the channel section (7a) away from the outlet nozzle (4) and with its end section passing through the first channel (7a) forms the insert part (14).

14. Cannula according to any of preceding claims 1 to 12,
characterized in that,
the impact wall (13) extends approximately at right angles to the angle bisector (Wh) of the angle (W1).

15. Cannula according to any preceding claim,
characterized in that,
the impact wall (3) is exchangeable and preferably held by means of a base body (48) releasably connected with the cannula shaft (3).

16. Cannula (1) for a medical or dental-medical handpiece (61b) for spraying a flow medium (6) that contains abrasively effective particles, having
a cannula foot (2),
a cannula shaft (3) extending substantially straight forwardly from the cannula foot (2),
an outlet nozzle (4) in the forward end region of the cannula shaft (3), directed sideways,
whereby in the cannula shaft (3) a first channel section (7a) of a first delivery line (5) extends axially forwardly, from which there extends a second channel section (7b) sideways to the outlet nozzle (4), characterized in that,
in the cannula (1) there extends a second delivery line (21) from an inlet opening (21a) in the region of the cannula foot (2) to a ring nozzle (21c) surrounding the second channel section (7b) in the region of the outlet nozzle (4),
wherein a third channel section (21b) of the second delivery line (21) extends forwardly in substance parallel to the first channel section (7a) over a length section in the rearward end region, and
wherein the third channel section (21b) is formed by a ring gap (21d) which surrounds a straight channel sleeve (22) emplaced in the cannula shaft (3) and forming the first channel section (7a), and is connected in its forward end region with the ring nozzle (21c) by means of at least one continuing connection channel (58).

17. Cannula according to claim 16,
characterized in that,
the ring gap (21d) is formed in that the channel sleeve (22) is continuously tapered in a ring-shape from its rearward end region forwardly.

18. Cannula according to claim 16 or 17,
characterized in that,
in the second delivery line (21) there is arranged a return flow blocking valve (35a, 35b).

19. Cannula (1) for a medical or dental-medical handpiece (61a, 61b) in particular for a medical or dental-medical handpiece (61a, 61b) for spraying a flow medium (6) which contains abrasively effective particles, having a through-going channel (21),
characterized in that,
a return flow blocking valve (35a, 35b) is arranged in the channel (21).

20. Cannula according to claim 18 or 19,
characterized in that,
the return flow blocking valve (35a, 35b) is a membrane valve or a lip valve.

21. Cannula according to any of claims 18 to 20,
characterized in that,
the return flow blocking valve (35a, 35b) is or are arranged in the region of the outlet nozzle (4) and/or in the middle region of the cannula (1).

22. Cannula according to claim 20 or 21,
characterized in that,
the return flow blocking valve (35a) has a ring-like membrane (52) the inner or outer edge of which is axially fixed and the respective other edge (53) cooperates sealingly with a ring surface (8) and is a axially elastically bent outwardly through the flow pressure of the flow medium (6).

23. Cannula according to claims 18 to 22,
characterized in that,
the return flow blocking valve (35b) is arranged accessible from the rear in a rearward recess (41a), which is preferably closed by a closure part (37).

24. Cannula (1) for a medical or dental-medical handpiece (61a) for spraying a flow medium (6) which contains abrasively effective particles, having
a cannula shaft (3) which is in substance straight
a sideways directed outlet nozzle (4) in the forward end region of the cannula shaft,
wherein in the cannula shaft (3) a first channel section (7a) of a delivery line (5) extends axially forwardly, from which there extends a second channel section (7b) sideways to the outlet nozzle (4),
or a cannula according to any preceding claim,
characterized in that,
the cannula shaft (3) is of two longitudinal sections (1a, 1b) which are connected with one another by means of a connecting device (19) in the form of a plug-in connection or a screw connection.

25. Cannula according to claim 24,
characterized in that,
the connecting device (19) is formed by means of a connection recess (19c) arranged at the end face on the one longitudinal section (1a) and a connection pin (19d) arranged on the other longitudinal section (1b) and sitting in the plug-in recess (19c).

26. Cannula according to claim 24 or 25,
characterized in that,
the outer surfaces of the longitudinal sections (1a, 1b) end flush with one another.

27. Cannula according to any of claims 24 to 26,
characterized in that,
a second delivery section (21), for a treatment liquid, in particular water, extends to the outlet nozzle (4).

28. Cannula according to claim 27,
characterized in that,
the second delivery line (21) has in the forward cannula section (1b) a line section (103) extending from the rearward end thereof forwardly, which with regard to the first channel section (7a) is offset to the side, in particular is offset towards the outlet nozzle (4).

29. Cannula according to claim 28,
characterized in that,
a line section (21d) extending longitudinally in the rearward longitudinal section (1a) and the line section (103) in the forward longitudinal section (1d) are connected with one another by means of a radial channel which is preferably formed by means of a gap (104) between the longitudinal sections (1a, 1b) arranged in the base of the connection recess (19c).

30. Medical or dental-medical handpiece (61a, 61b) for spraying a flow medium (6) that contains abrasively effective particles, having
a coupling element (64) for releasable connection of a flexible supply line, arranged in its rearward end region,
a cannula (1) which has at its forward end the outlet nozzle (4),
a supply container (67) for abrasive particles arranged in the rearward end region of the handpiece (61a, 61b), and
a first delivery line (5) which extends from the coupling element (64) through the supply container (67) to the outlet nozzle (4),
characterized in that,
that at least a section of the supply container (67) at least on its inner side,
and/or at least a line sleeve (81, 22, 8) extending between the supply container (67) and the outlet nozzle (4), and/or the outlet nozzle (4), is or are of a wear resistant plastic.

31. Handpiece according to claim 24,
characterized in that,
the plastic is polyurethane (PUR) or polyetheretherketone (PEEK).

32. Handpiece according to claim 24 or 25
characterized in that,
that the hardness is about 70 to 100 Shore or at least about 150 N/mm², in particular about 180 to 220 N/mm², in accordance with the European standard EN ISO 2039-1.

33. Handpiece according to claim 24 or 25,
characterized in that,
the supply container (67) has a pot-shaped container part (67a) which at its inner side or overall is of plastic.

34. Handpiece according to any of claims 24 to 27,
characterized in that,
the plastic is non-transparent, preferably penetration dyed, in particularly penetration dyed black.

35. Cannula or handpiece according to any of claims 5 to 28,
characterized in that,
the plastic has a modulus of elasticity (Gpa) in tensile testing of about 3.7 to 4.0.

36. Cannula (1) for a medical or dental-medical handpiece (61a) for spraying a flow medium (6) which contains abrasively effective particles, having
a cannula shaft (3) which is in substance straight
a sideways directed outlet nozzle (4) in the forward end region of the cannula shaft,
wherein in the cannula shaft (3) a first channel section (7a) of a delivery line (5) extends axially forwardly, from which there extends a second channel section (7b) sideways to the outlet nozzle (4), or a cannula according to any preceding claim,
characterized in that,
the first cannula section (7a) has a channel widening (107) in its forward end region.

37. Cannula according to claim 36,
characterized in that,
the channel widening (107) is formed in that a sleeve (22) in the first delivery line section (7a) ends at a spacing before the second delivery channel (7b).

38. Cannula according to claim 36 or 37,
characterized in that,
the channel widening (107) transitions convergently, in particular hollow conically, into the second channel section (7b).

39. Cannula according to any of preceding claims 36 to 38,
characterized in that,
the outlet nozzle (4) has a nozzle sleeve (8) which sits in a receiving hole (9) in the cannula (1), and in that the receiving hole (9) is extended beyond the first delivery line (7a) in the cannula (1), in particular is formed as a through-going hole and is closed at its end away from the outlet nozzle (4).
